(19) United States
(12) Patent Application Publication
(10) Pub. No.: US 2015/0292724 A1
(43) Pub. Date: Oct. 15, 2015

(54) LENS FOR LIGHTING DEVICES, CORRESPONDING LIGHTING DEVICE AND METHOD

(71) Applicant: Osram GmbH, Munich (DE)

(72) Inventors: Alessio Griffoni, Fosso (IT); Franco Zanon, Cassola (IT)

(21) Appl. No.: 14/685,638

(22) Filed: Apr. 14, 2015

(30) Foreign Application Priority Data
Apr. 15, 2014 (IT) TO2014A000317

(51) Int. Cl. F21V 23/06; F21K 99/00; F21V 5/04

(52) U.S. Cl. CPC F21V 23/06; F21V 5/048; F21K 9/50; F21K 9/90; F21Y 2101/02

(57) ABSTRACT

Various embodiments may relate to a lens couplable to a light radiation source, e.g. a LED source, so as to be traversed by the light radiation produced by the latter. The lens includes, embedded in the lens itself, at least one electrically conductive line adapted to enable the electrical supply of the light radiation source.

### CROSS-REFERENCE TO RELATED APPLICATION

This application claims priority to Italian Patent Application Serial No. T02014A000317, which was filed Apr. 15, 2014, and is incorporated herein by reference in its entirety.

### TECHNICAL FIELD

Various embodiments may relate to lenses for lighting devices.

Various embodiments may refer to lighting devices making use, as light radiation sources, of solid-state sources such as LED sources.

### BACKGROUND

Lighting devices, such as for example LED modules for outdoor use, may meet requirements such as:

high luminous flux (e.g. >10,000 lm);
high power efficiency (e.g. >110 lm/W), which may require on one hand low thermal resistance, and on the other hand a high efficiency of the optical system (>90%);
high electrical insulation (e.g. >2 kV AC);
high reliability in terms of high rated lumen maintenance life (e.g. 60,000 hours) and low catastrophic failure rate (e.g. the solder joints have to survive at least 5000 thermal cycles);
modularity;
low cost in term of both Bill of Materials (BoM) and manufacturing process.

Meeting such requirements may be a challenge.

In order to achieve a high optical efficiency it is possible to use optics, e.g. lenses.

On the Printed Board Assembly (PBA) side it is possible to resort to various implementations which, while satisfying some of the previously outlined needs, on the other hand may jeopardize other necessary features.

For example, a first solution consists in the use of a distributed array of light radiation sources, such as for instance high power LEDs with ceramic package (AlN or Al₂O₃), soldered on an Insulated Metal Substrate (IMS) board. The unit is then assembled on a heatsink (or a thermally dissipative housing, such as a metal, e.g. aluminium, housing) via a thermally-conductive glue or screws.

This solution has some limits, for example the reduced reliability of the solder joints due to the possible high Coefficient of Thermal Expansion (CTE) mismatch between the ceramic package of the light radiation source (e.g. the LED source) and the base metal (e.g. aluminium) of the board.

Another limit of such a solution is the need to reach a trade-off between the dielectric electrical breakdown, that affects the electrical insulation, and the thermal resistance. Actually, IMS boards with low thermal resistance have a rather low dielectric breakdown.

Another PBA implementation may consist in using a distributed array of light radiation sources (e.g. power LEDs with ceramic package) soldered on a ceramic board (AlN o Al₂O₃). The resulting unit may afterwards be assembled on a heatsink (or a thermally dissipative housing, for example of a metal as aluminium) via a thermally conductive adhesive bonding.

Under such circumstances, the thermal resistance can be similar or even lower compared to an IMS board, while the dielectric insulation may not be a critical issue, because it may be higher than 20 kV/mm with a film thickness higher than 0.3 mm.

Moreover, this implementation may show a higher reliability of solder joints, because it is possible to drastically reduce the CTE mismatch between the package of the light radiation source and the board.

However, such a solution cannot be used for a distributed LED array with a high number of LEDs, and/or in case of a large LED-to-LED pitch, because of the limited board area that may be achieved and because of the rather high cost (more than 400 [symbol] /m²).

Another PBA implementation may consist in using Chip-on-Board (CoB) components manufactured on an IMS or ceramic substrate. The CoBs may be assembled on a heatsink (or a thermally dissipative housing, e.g. made of a metal such as aluminium) via a thermally-conductive glue or screws.

In the case of IMS-based CoBs, the dielectric insulation can be managed more easily with respect to packaged LEDs soldered on IMS boards. The possibility to omit a package in CoB components may lead to a reduced thermal resistance in comparison with LEDs inserted into a package and soldered on IMS boards.

As a consequence, with CoB components it is possible to use a dielectric with a higher dielectric breakdown but with a thermal conductivity which is at least slightly lower.

In the case of ceramic-based CoBs, ceramics with low thermal conductivity (for example Al₂O₃) may be used, because of the absence of the LED package.

Moreover, the dielectric breakdown may not constitute a significant issue, for the same reasons described for the ceramic boards.

Besides, the reliability of solder joints is not an issue, regardless of the board type employed, because the solder joints are no longer present.

The CoB solution is also attractive for cost reasons. Indeed, in some implementations it is possible to achieve up to 35% cost saving with respect to the PBA solutions using packaged LEDs soldered on an IMS board.

However, CoB solutions may have some constraints.

For example, a first constraint may be linked to the use of big lenses, which are not easy to manufacture; this may require a trade-off among the size of the optical lenses, the size of the CoBs and the costs.

Another constraint regards the interconnection between different CoBs. Such interconnections can be produced by manually soldering wires extending from a CoB to another CoB; however, there is a risk that such action may affect the dielectric breakdown features in IMS-based CoBs, leading to a possible reduction of electrical insulation.

Another possibility consists in using an additional board (for example a FR4 single layer board) as power bus line, employing connectors for the interconnection with the several CoBs; however, the use of several connectors may generate additional costs, and give rise to solutions which are not competitive in terms of cost.

### SUMMARY

In various embodiments, said object may be achieved thanks to a lens having the features specifically set forth in the claims that follow.

Various embodiments may also refer to a corresponding lighting device, as well as to a corresponding method.

Various embodiments may envisage a way to bring about the electrical interconnection between electrically powered light radiation sources (for example CoB elements or dense LED clusters mounted on small boards) and/or towards any other system which employs optical lenses.

In various embodiments, electrically conductive (e.g. copper) interconnection lines may be embedded in the optical lenses (for example made of plastics) by using processes such as co-moulding, plasma deposition or Laser Direct Structuring (LDS).

In various embodiments, by using co-moulding or plasma deposition it is possible to use standard polymer-based lenses, for example of polymethylmetacrylate (PMMA).

In various embodiments, by using an LSD process, it is possible to use plastic materials compounded with a catalyst.

In various embodiments, an optical lens with conductive, e.g. copper, lines may have such a shape as to envelope or surround a corresponding light radiation source (for example a CoB element) which is fixed by screws or glue on a heatsink or a thermally dissipative housing. This is done while ensuring a correct positioning between the light radiation source and the lens and, optionally, with the possibility to accommodate a plug-in connector, for example with sliding contacts.

In various embodiments, the electrical connection between the optical lenses and the light radiation sources (e.g. CoBs) may be obtained with an electrically conductive adhesive applied between the electrically conductive pads (e.g. copper pads) of both objects, or using the spring contacts commonly employed in optical lenses.

Various embodiments may lead to obtaining one or more following advantages:
easy interconnection among light radiation sources (e.g. CoBs or small boards mounting LED clusters);
high power efficiency;
possibility of reaching an electrical insulation together with low thermal resistance;
high reliability in terms of lumen maintenance and solder-joint reliability.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIGS. 1 and 2 show in perspective views, from different viewpoints, examples of embodiments;

FIGS. 3 and 4 exemplify mounting arrangements of embodiments;

FIG. 5 shows in more detail the portion of FIG. 4 denoted by arrow v,

FIG. 6 exemplifies various embodiments,

FIGS. 7 and 8 exemplify mounting arrangements of embodiments,

FIG. 9 is a view that approximately corresponds to arrow IX of FIG. 8,

FIGS. 10 and 11 show in perspective views, again from different viewpoints, various embodiments, and

FIGS. 12 and 13 exemplify mounting arrangements of embodiments.

### DETAILED DESCRIPTION

In the following description, numerous specific details are given to provide a thorough understanding of various exemplary embodiments. One or more embodiments may be practiced without one or several specific details, or with other methods, components, materials, etc. In other instances, well-known structures, materials, or operations are not shown or described in detail to avoid obscuring aspects of the embodiments. Reference throughout this specification to “an embodiment” means that a particular feature, structure, or characteristic described in connection with the embodiment is included in at least one embodiment. Thus, the possible appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

The Figures exemplify one or various embodiments of lenses 10 adapted to be used together with electrically powered light radiation sources, such as solid-state light radiation sources, e.g. LED sources.

In various embodiments, lens 10 may include a body of a material which is transparent to light radiation in the visible range. Transparent polymers such as, for example, polymethylmetacrylate (PMMA) or plastic materials compounded with a catalyst are examples of such a material.

In various embodiments, lens 10 may be produced via one of the technological processes which have already been mentioned in the introduction of the present description.

In various embodiments, the lens or each lens 10 may include a peripheral portion 10a which surrounds a portion 10b which constitutes the proper optical part of lens 10.

In various embodiments, portion 10b may have a general lenticular shape, e.g. a convex shape.

In various embodiments, peripheral portion 10a may have a polygonal external shape (e.g. a square shape in the presently shown examples) which may enable mounting several lenses 10 in an array (e.g. a matrix).

In ovarious embodiments, a lens 10 may be provided with electrically conductive lines 12, e.g. of a metal material such as copper, which are embedded in lens 10 by resorting e.g. to one of the previously mentioned technologies, i.e. by using such processes as co-moulding, plasma deposition or Laser Direct Structuring (LDS).

For example, conductive lines 12 may be respectively positive and negative supply lines for one or more electrically powered light radiation sources (e.g. LED sources) 14, to which lens 10 can be coupled according to arrangements which will be better detailed in the following.

In various embodiments, electrically conductive lines 12 may have contact terminal parts 12, 12b emerging at the lens 10 surface.

In various embodiments as exemplified herein, one or more terminals 12a may face laterally from lens 10, e.g. they may be arranged along one of the sides of peripheral portion 10a, if it is present, so as to accommodate plug-in sliding contacts of power supply lines (which are not visible in the drawings).

In various embodiments, lines 12 embedded in lens 10 may extend on the rear side of lens 10 itself, i.e. the opposite side to the front side, through which light radiation is propagated outside.

In various embodiments, one or more terminal parts 12b may therefore enable an electrical contact with electrical supply pads of the light radiation sources 14.

In various embodiments the sources consist in electrically powered light radiation sources, such as LEDs implementing e.g. the CoB technology.

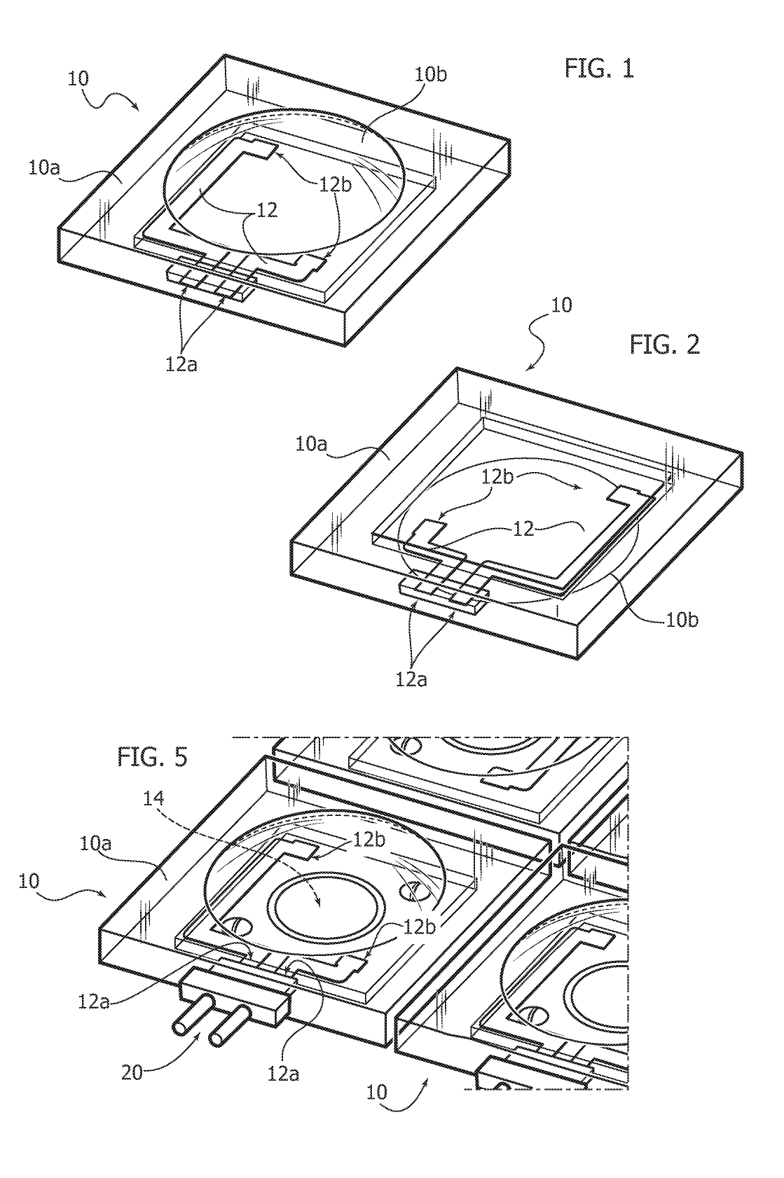

FIG. 1 is a general perspective view of a described lens 10 observed from the front side, while FIG. 2 is a view from the rear side.

In various embodiments exemplified in FIGS. 1 and 2, the peripheral portion 10a of lens 10 may be shaped so as to form a sort of frame (with a square external shape, in the presently shown example) adapted to surround the light radiation source(s) 14 to which lens 10 is associated.

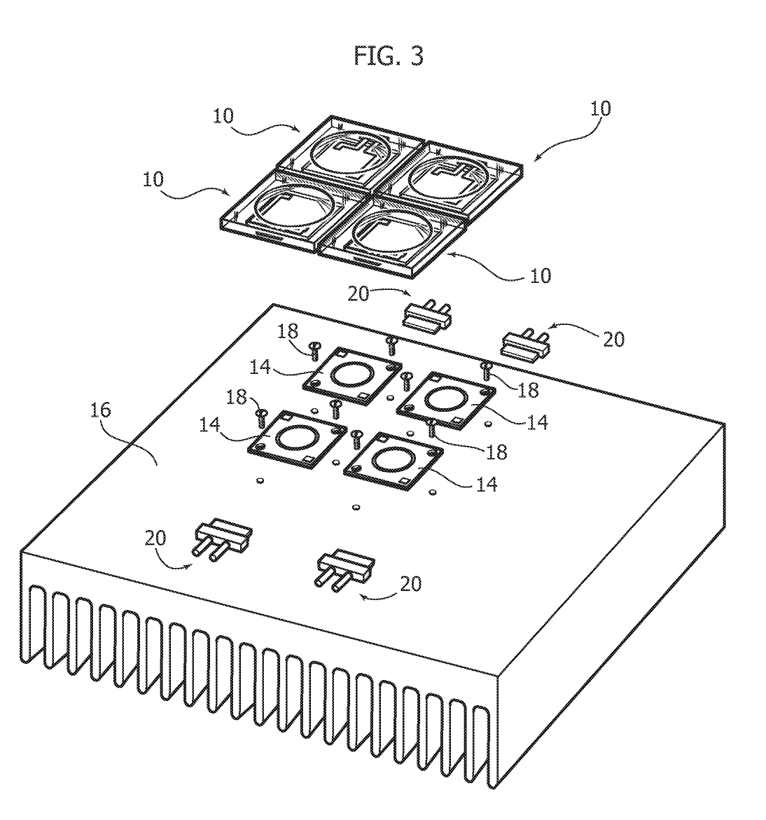

FIG. 3 exemplifies the possibility to use a plurality of lenses 10 arranged in a matrix array, each lens 10 being associated to a respective light radiation source 14.

The example of FIG. 3 refers, by way of example only, to the use of N=4 lenses, each of a square shape, arranged in a square 2×2 matrix.

Of course, both the shape of lens 10 and the general shape of the array formed by putting several lenses 10 together, and the arrangement of lenses 10 in such an array may be chosen at will.

FIGS. 3 and 4 exemplify a possible assembly sequence of a lighting device which employs, as a mounting support of light radiation sources 14 and of the lenses 10 associated thereto, a thermally dissipative support 16.

In various embodiments, support 16 may include a heat sink (e.g. with fins) or a thermically conductive housing, such as a metal housing.

In various embodiments, light radiation source(s) 14 may be mounted on substrate 16 e.g. via screws 18 or an electrically conductive adhesive.

On the conductive pads of power sources 14 there may be arranged an electrically conductive material, for example an electrically conductive adhesive.

As it will be better understood from the sequence of FIGS. 3 and 4, the lens(es) may be arranged on top of the light radiation sources 14 in the desired aligned position, e.g. so that the peripheral portion 10a of the lens or of each lens 10 can surround or “envelope” a respective light radiation source 14.

The electrical connection between electrically conductive lines 12 (ends 12b in the drawings) and the conductive pads of sources 14 may be finished by curing the previously mentioned electrically conductive adhesive.

One or more electrical connectors 20 may be plugged in by sliding, in order to contact the ends 12a of electrically conductive lines 12.

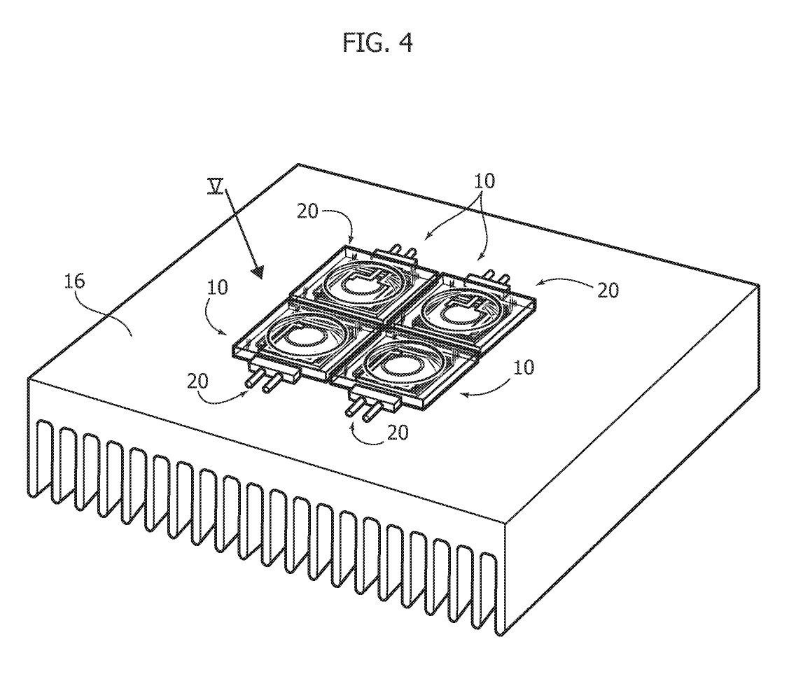

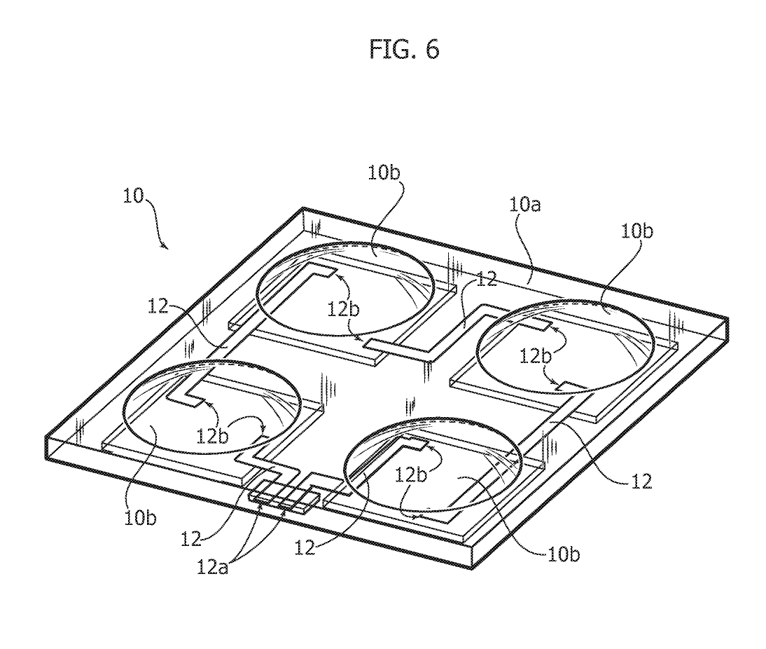

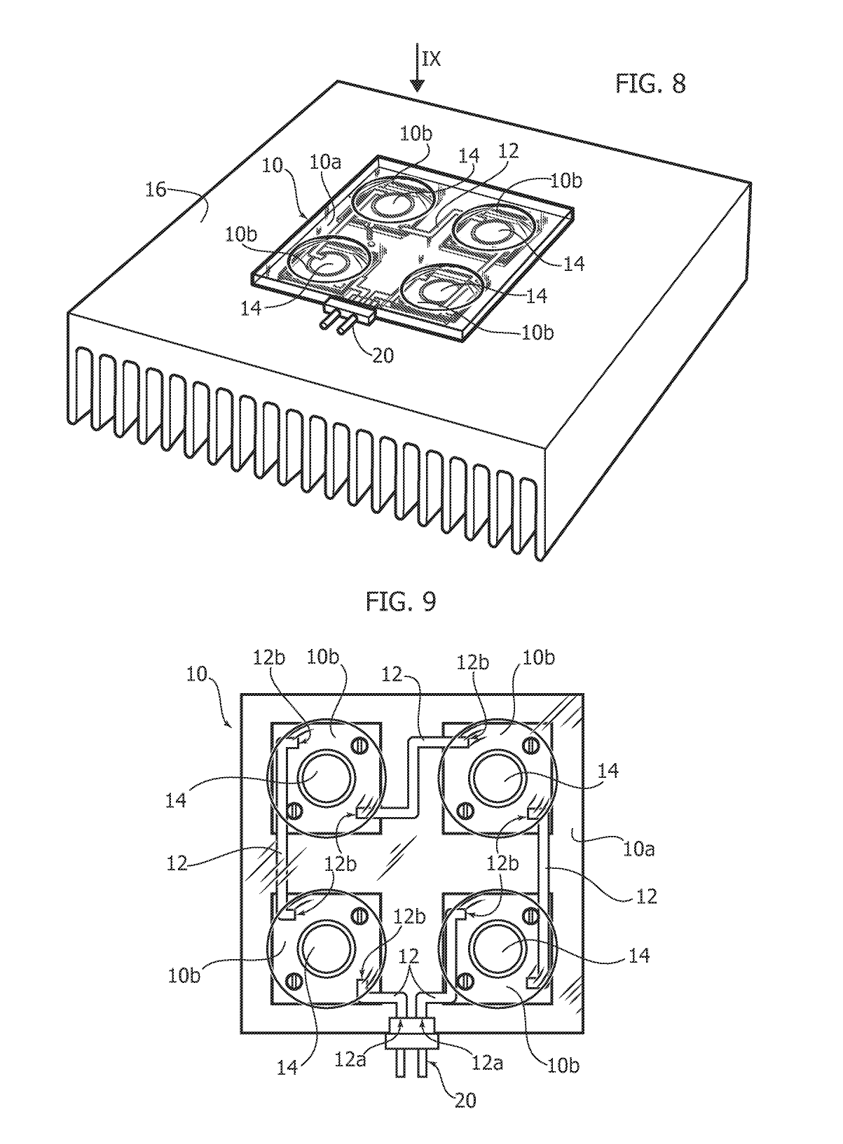

FIGS. 6 to 13 exemplify possible embodiments which are different from the embodiments exemplified in FIGS. 1 to 5.

In this respect, it will be appreciated that parts or elements identical or similar to parts or elements already described with reference to FIGS. 1 to 5 are denoted in FIGS. 6 to 13 by the same reference numbers; as a consequence, the corresponding detailed description thereof will be omitted herein.

Of course, parts or elements denoted with the same reference in different Figures need not necessarily be implemented in the same way in various possible embodiments.

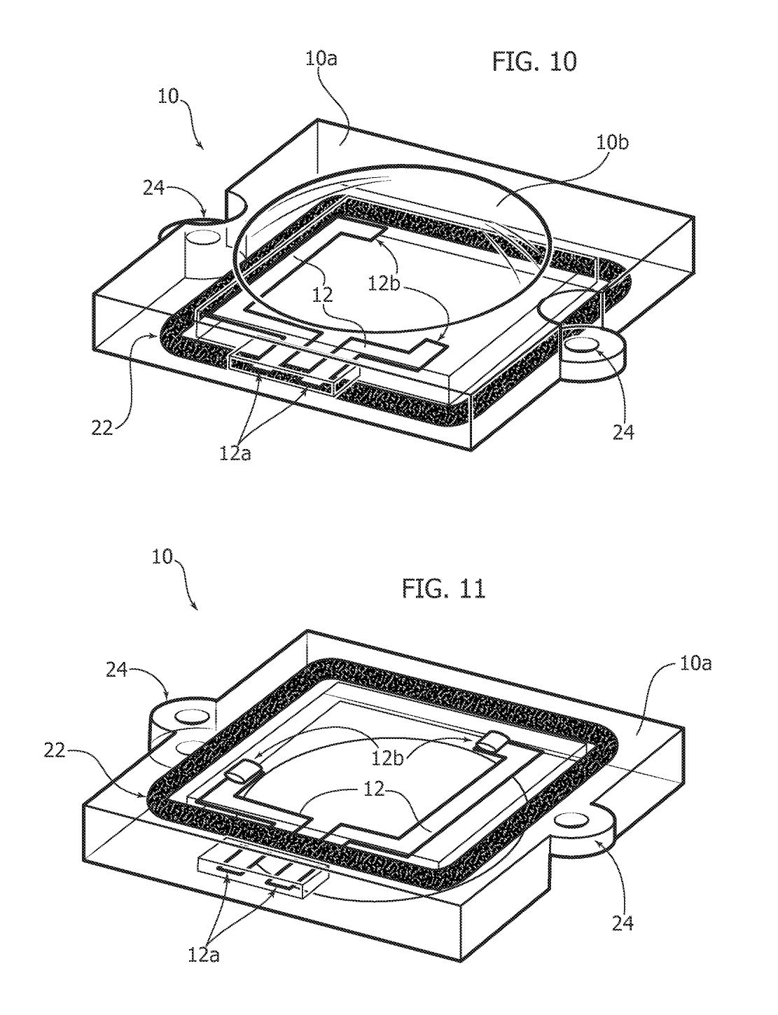

Moreover, one or more features exemplified herein while referring, for example, to FIGS. 1 to 5 or to FIGS. 6 to 9 or else to FIGS. 10 to 13 may be freely employed in embodiments exemplified in different Figures.

FIGS. 6 to 9 exemplify the possibility to integrate in one single element several lenses 10 shown as different parts in the examples of FIGS. 1 to 5.

In various embodiments, such an integration may be implemented as a “composite” lens including a plurality of lenticular portions 10b (i.e. proper “lenses”) which are interconnected, for example in a 2×2 matrix pattern, through their respective peripheral portions 10a.

Referring to the embodiments exemplified in FIGS. 6 to 9, too, it will be appreciated that both the number N of lenticular portions 10b included in lens 10 (in the presently exemplified embodiment N=4) and the arrangement of such lenticular portions within lens 10, and also the general shape of lens 10, may be chosen at will.

In various embodiments as exemplified in FIGS. 6 to 9, in lens 10 there may be embedded electrically conductive lines 12 which are obtained via one of the technologies quoted in the introduction of the present description (e.g. by co-moulding).

Also in the embodiments exemplified in FIGS. 6 to 9, electrically conductive lines 12 may have terminals 12a which may slidingly accommodate electrical connectors such as connectors 20, as well as terminals 12b adapted to be connected to the electrical connection pads of light radiation sources 14.

FIGS. 6 to 9 highlight the fact that, in various embodiments as exemplified therein, electrically conductive lines 12 may extend from terminals 12a (adapted to be considered as supply terminals) towards a first light radiation source 14, from the latter to a second light radiation source 14 and from this on towards other light radiation sources to which the “composite” lens 10 is associated.

In this way, in various embodiments it is possible to achieve a series electrical connection of light radiation sources 14. Taking into account the fact that the arrangement of the electrically conductive lines 12 may be chosen at will, in various embodiments the connection of light radiation sources 14 may be, totally or partially, a parallel connection, according to the application requirements.

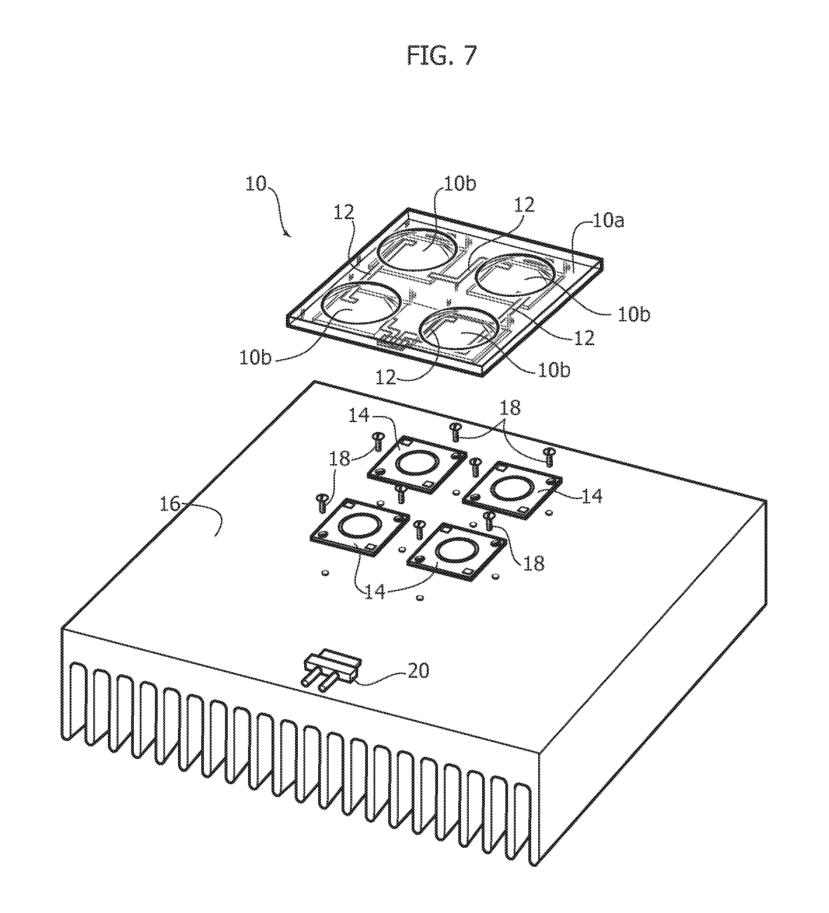

In various embodiments as exemplified in FIGS. 6 to 9, the mounting sequence (schematically represented in the sequence of FIGS. 7 and 8) may envisage the mounting of light radiation sources 14 on substrate 16, e.g. with a fixing through screws 18 or a thermally conductive adhesive, by applying a thermally conductive adhesive on the terminals 12b which must form the contact with and between the light radiation sources 14.

The composite or multiple lens 10 may be applied on top of the light radiation sources 14, while achieving the desired alignment among the optical portions 10b and the light radiation sources 14.

Then the adhesive or soldering mass applied on the terminals 12b is cured, and optionally the electrical connector(s) 20 are plugged in according to the previously described procedure.

In this case, too, peripheral portions 10a of lens 10 may surround the proper optical portions 10b, each portion 10a forming a sort of frame adapted to surround a respective light radiation source 14 therein, protecting it from the outer environment.

Such a function is further shown in the examples of FIGS. 10 to 13, wherein the possibility is exemplified to interpose, between lens 10 (peripheral portion 10a, in the presently shown example) and the surface of the thermally dissipative support 16, a gasket 22, for example of a silicone material, so as to obtain a better seal (IP protection) around light radiation source 14.

As previously stated, the solution presently exemplified with reference to FIGS. 10 to 13 may be applied to the embodiments shown in the other Figures, as well.

In the same way, FIGS. 10 to 13 exemplify the possibility, which may be applied to the other presently shown solutions as well, to provide conductive lines 12 with terminals (e.g. one or more terminals 12b) which are implemented as spring contacts. These spring contacts are adapted to achieve an electrical contact with the supply pads of the light radiation sources 14 as a consequence of a pressure contact, i.e. without requiring the use of a soldering mass such as an electrically conductive adhesive.

In various embodiments, lens 10 may be provided with openings 24 (e.g. in the form of slots) for the passage of mounting screws 26.

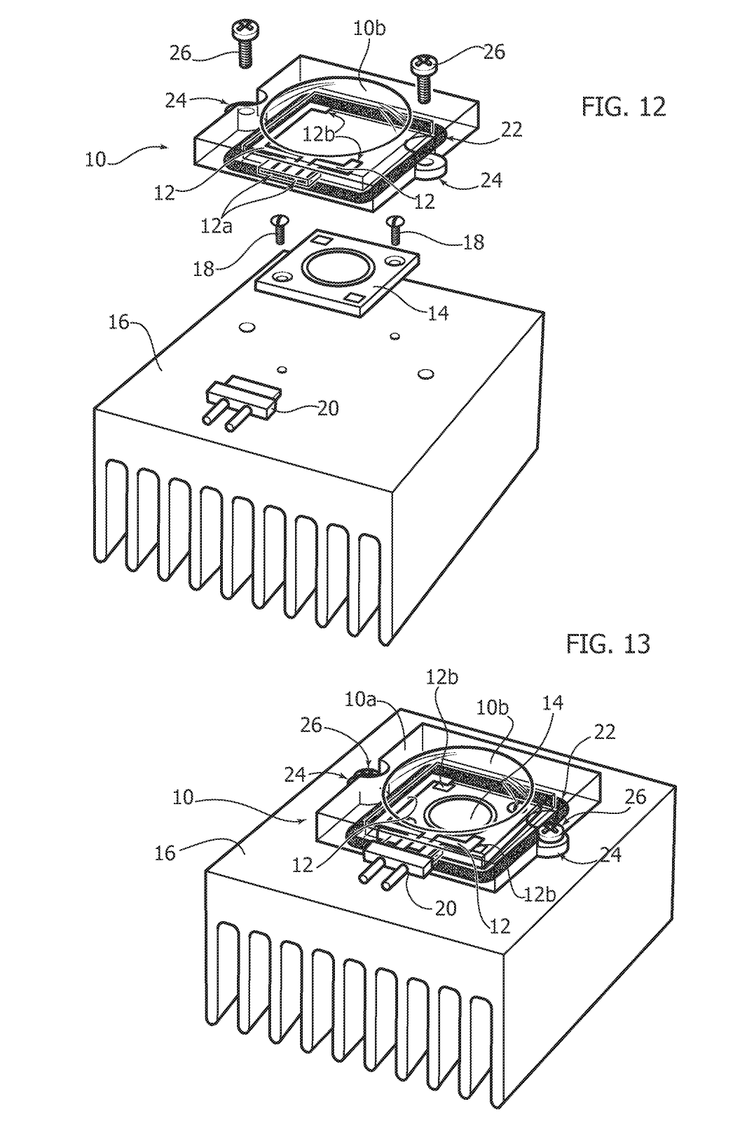

In this case, as exemplified by the sequence of FIGS. 12 and 13, the mounting sequence may envisage, after the mounting of the light radiation source(s) 14 on support 16 (for example through screws 18 or through an adhesive) the application of lens 10 with the following fixing thereof with screws 26.

In various embodiments, the thusly exerted pressure may allow, also thanks to the possible presence of gasket 22, to obtain a certain degree of protection, for example of IP level.

The pressure of lens 20 against the surface of support 16, for example via screws 26, may lead the spring contact terminals 12b to bring about a firm pressure contact with the pads of the light radiation sources 14.

In various embodiments, this solution (which is applicable to the embodiments exemplified in FIGS. 1 to 9, as well) may also simplify the mounting process of the lighting device.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A lens for coupling to an electrically powered light radiation source to be traversed by light radiation produced thereby, the lens comprising at least one electrically conductive line embedded in the lens.

2. The lens of claim 1, wherein said at least one electrically conductive line is embedded in the lens by any of:
the at least one electrically conductive line (is co-moulded with the lens,
the at least one electrically conductive line is plasma-deposited on the lens, or
the at least one electrically conductive line is formed on the lens by Laser Direct Structuring or LDS.

3. The lens of claim 1, wherein said at least one electrically conductive line includes at least one terminal emerging at the lens surface.

4. The lens of claim 1, wherein said at least one electrically conductive line includes at least one terminal formed as a plug-in connector.

5. The lens of claim 1, wherein said at least one electrically conductive line includes at least one terminal formed as a spring contact.

6. The lens of claim 1, wherein said at least one electrically conductive line is arranged at the rear side of the lens.

7. The lens of claim 1, further comprising a peripheral portion surrounding an optical portion of the lens, wherein said at least one electrically conductive line includes terminals emerging at the lens surface outwardly and inwardly of said peripheral portion.

8. The lens of claim 1, further comprising a peripheral portion surrounding an optical portion of the lens, wherein a gasket is coupled to said peripheral portion.

9. The lens of claim 1, wherein the lens is a composite lens including a plurality of optical portions with at least one electrically conductive line extending between two optical portions of said plurality.

10. A lighting device comprising:
a support member,
at least one electrically powered light radiation source mounted on said support member,
at least one lens, the lens comprising at least one electrically conductive line embedded in the lens, the lens mounted on said support member to be traversed by light radiation produced by said at least one source, with said at least one electrically conductive line embedded in the lens providing electrical contact to said at least one light radiation source.

11. A method of producing a lighting device, the method comprising:
providing a support member,
mounting at least one electrically powered light radiation source on said support member, and
mounting on said support member at least one lens to be traversed by light radiation produced by said at least one source, wherein the lens includes at least one electrically conductive line embedded in the lens, with said at least one electrically conductive line providing electrical contact to said at least one light radiation source.
